(19) United States
(12) Patent Application Publication
(10) Pub. No.: US 2026/0203183 A1
(43) Pub. Date: Jul. 16, 2026

(54) USER EQUIPMENT AND METHOD FOR PRIORITIZING AND CONTEXTUALIZING USER DATA

(71) Applicant: Samsung Electronics Co., Ltd., Suwon-si (KR)

(72) Inventors: Vipul GUPTA, Noida (IN); Abhishek SHARMA, Noida (IN); Nisha KAUSHIK, Noida (IN); Aman TALWAR, Noida (IN); Saurav KISHORE, Noida (IN)

(73) Assignee: Samsung Electronics Co., Ltd., Suwon-si (KR)

(21) Appl. No.: 19/565,165

(22) Filed: Mar. 12, 2026

Related U.S. Application Data
(63) Continuation of application No. PCT/KR2025/022520, filed on Dec. 22, 2025.

(30) Foreign Application Priority Data
Dec. 24, 2024 (IN) 202411102428

(51) Int. Cl. G06F 11/34

(52) U.S. Cl. CPC G06F 11/3438

(57) ABSTRACT

A method for prioritizing and contextualizing user data on a user equipment, includes: identifying a plurality of parameters associated with user behavior by analyzing at least one of entities, relations, and contexts in structured user data using a machine learning (ML) model; identifying at least one behavioral pattern of the user behavior based on the plurality of parameters; mapping the at least one behavioral pattern to the contexts; prioritizing the entities and the relations based on the mapped at least one behavioral pattern; predicting, using the ML model, a plurality of chains of thought based on priority of the entities and the relations; identifying a chain of thought having a highest probability of occurrence, among the plurality of chains of thought, by comparing the plurality of chains of thought using the ML model; and prioritizing and contextualizing the user data based on the chain of thought having the highest probability of occurrence.

### CROSS-REFERENCE TO RELATED APPLICATIONS

This application is a continuation of International Application No. PCT/KR 2025/022520, filed on Dec. 22, 2025, which is based on and claims priority to Indian Patent Application No. 202411102428, filed on Dec. 24, 2024, in the Indian Patent Office, the disclosures of which are incorporated by reference herein in their entireties.

### BACKGROUND

### 1. Field

The present disclosure relates to a user equipment, and more particularly, to a user equipment and method for prioritizing and contextualizing user data on user equipment.

### 2. Description of Related Art

User equipment (UE), such as smartphones or tablets, is used extensively for personal and professional purposes. The UEs are designed and engineered to install a plurality of applications thereon. For instance, e-mail applications installed on the UE may provide e-mail support, text communication applications may provide text-based communication, a photo application may store and access images, and a notes application may provide note-taking functionality.

A user may connect with other people over different applications in relation to the same task. As a result, the content associated with the same task may be present in different applications. Further, such a large volume and diversity of this communication may lead to information overload, thereby making it difficult to manage and access information efficiently. One of the ways to mitigate this issue may include synchronizing information from different accounts in the application. However, such integration is limited to a single application and cross-application integration is not supported.

### SUMMARY

According to an aspect of the disclosure, a method for prioritizing and contextualizing user data on a user equipment, includes: identifying a plurality of parameters associated with user behavior by analyzing at least one of entities, relations, and contexts in structured user data using a machine learning (ML) model; identifying at least one behavioral pattern of the user behavior based on the plurality of parameters; mapping the at least one behavioral pattern to the contexts; prioritizing the entities and the relations based on the mapped at least one behavioral pattern; predicting, using the ML model, a plurality of chains of thought based on priority of the entities and the relations; identifying a chain of thought having a highest probability of occurrence, among the plurality of chains of thought, by comparing the plurality of chains of thought using the ML model; and prioritizing and contextualizing the user data based on the chain of thought having the highest probability of occurrence.

According to an aspect of the disclosure, a user equipment includes: memory storing instructions; and at least one processor operatively coupled with the memory, wherein the instructions, when executed by the at least one processor individually or collectively, causes the user equipment to: identify a plurality of parameters associated with user behavior by analyzing at least one of entities, relations, and contexts in structured user data using a machine learning (ML) model; identify at least one behavioral pattern of the user behavior based on the plurality of parameters; map the at least one behavioral pattern to the contexts; prioritize the entities and the relations based on the mapped at least one behavioral pattern; predict, using the ML model, a plurality of chains of thought based on the priority; identify the chain of thought having a highest probability of occurrence, among the plurality of chains of thought, by comparing the plurality of chains of thought using the ML model; and prioritize and contextualize the user data based on the chain of thought having the highest probability of occurrence.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a user equipment (UE) including a system for prioritizing and contextualizing user data on the UE, according to an embodiment of the disclosure;

FIG. 2 illustrates a block diagram of the system, according to an embodiment of the disclosure;

FIG. 3 illustrates a block diagram showing interactions among different modules of the system, according to an embodiment of the disclosure;

FIG. 4 illustrates a flow diagram of a data harvesting module of the system, according to an embodiment of the disclosure;

FIG. 5A illustrates a flow diagram illustrating capturing data from a non-native application, according to an embodiment of the disclosure;

FIG. 5B illustrates a flow diagram showing image processing of a screen recording for capturing data from the non-native application, according to an embodiment of the disclosure;

FIG. 6 illustrates a flow diagram of an insight extraction module of the system, according to an embodiment of the disclosure;

FIG. 7 illustrates a flow diagram of a chain of thought determination module of the system, according to an embodiment of the disclosure;

FIG. 8 illustrates a flow diagram of behavioral analysis, according to an embodiment of the disclosure;

FIG. 9 illustrates a flow diagram of priority prediction, according to an embodiment of the disclosure;

FIG. 10 illustrates a flow diagram for determining the chains of thought, according to an embodiment of the disclosure;

FIG. 11 illustrates a flow diagram of a recommendation module of the system, according to an embodiment of the disclosure;

FIG. 12 illustrates a flow diagram of a query module of the system, according to an embodiment of the disclosure;

FIG. 13 illustrates a method for validating access to the electronic device, according to an embodiment of the disclosure; and

FIG. 14 illustrates an embodiment of the working of the system, according to an embodiment of the disclosure;

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Embodiments of the disclosure will be described below in detail with reference to the accompanying drawings.

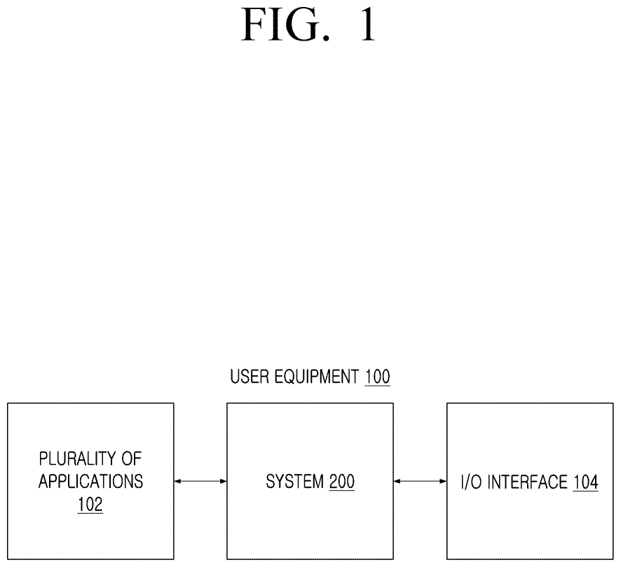

FIG. 1 illustrates a user equipment (UE) 100 including a system 200 for prioritizing and contextualizing user data on the UE, according to an embodiment of the disclosure. The system 200 may interact with a plurality of applications 102 to receive the user data and may provide insights to a user upon receipt of a query via an Input/Output (I/O) interface 104. The I/O interface 104, in an example, may include a touchscreen display, a microphone, and a speaker. Further, the touchscreen display may present a graphical user interface (GUI) to the user to receive a query and present a response to the user. Further, the microphone may allow a voice query from the user and the speaker may output an aural response to the user.

The system 200 of the disclosure may be configured to process the user data generated and stored in the plurality of applications 102 to prioritize and contextualize the user data. Prioritizing the user data may be understood as a step in determining a sequencing of presenting the user data to the user. Further, contextualizing the user data may be understood as a step of interpreting the user data to determine relevance and priority associated with the user data.

The system 200 of the disclosure may collate the user data and may generate predictions about the user's future actions. The predictions may also be referred to as chains of thought. The chains of thought may be indicative of the user's probable action or course of action. For instance, when the user data includes professional activities, such as scheduled client meetings and team meetings, the chains of thought may include assigning tasks to team members, setting deadlines for work products, and following up with the client and teams, among other examples. In another instance, when the user data includes travel and accommodation booking, discussion with co-travelers, such as friends or family, the chains of thought may include a planned itinerary, and possible cab booking activity, among other examples.

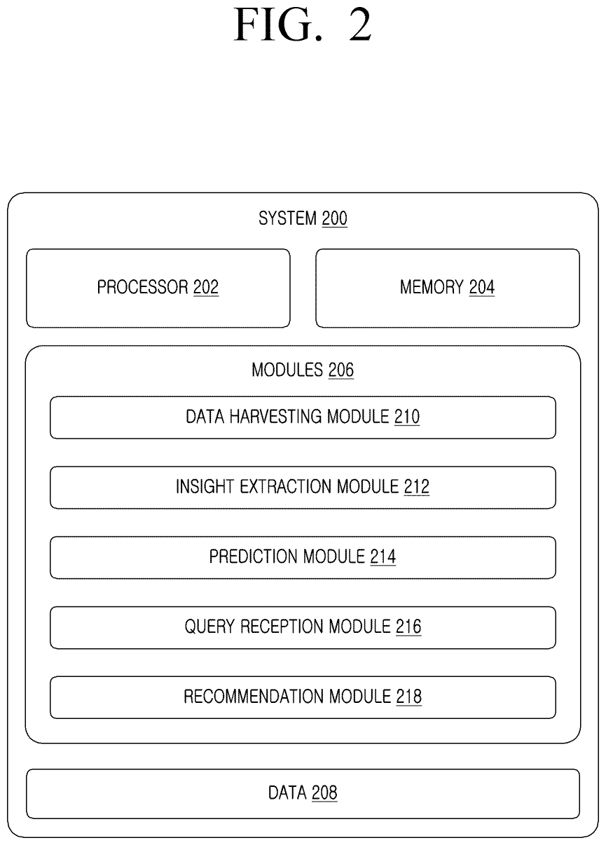

The system 200 may be capable of retrieving user data from a wide variety of applications which makes the implementation of the system 200 universal across different UEs. A manner, in which the system 200 operates, is explained with respect to FIG. 2.

FIG. 2 illustrates a block diagram of the system 200, according to an embodiment of the disclosure. The system 200 may include different components that operate synergistically to generate the hand pose. For instance, the system 200 may include at least one processor 202, memory 204, one or more modules 206, and data 208. The memory 204, in an example, may store the instructions that are executed by the at least one processor 202 individually or collectively to carry out the operations of the modules 206. The modules 206 and the memory 204 may be coupled to the processor 202.

The at least one processor 202 may be a single processing unit or several units, all of which could include multiple computing units. The processor 202 may be implemented as one or more microprocessors, microcomputers, microcontrollers, digital signal processor, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium including, for example, volatile memory, such as static random-access memory (SRAM) and dynamic random-access memory (DRAM), and/or non-volatile memory, such as read-only memory (ROM), erasable programmable ROM, flash memory, hard disks, optical disks, and magnetic tapes.

The modules 206 may include routines, programs, objects, components, data structures, and the like, which perform particular tasks or implement data types. The modules 206 may be implemented as, signal processor(s), state machine(s), logic circuitries, and/or any other device or component that manipulate signals based on operational instructions.

Further, the modules 206 may be implemented in hardware, instructions executed by a processing unit, or by a combination thereof. The processing unit may include a computer, a processor, such as the processor 202, a state machine, a logic array, or any other suitable devices capable of processing instructions. The processing unit may be a general-purpose processor 202 which executes instructions to cause the general-purpose processor 202 to perform the required tasks or, the processing unit may be dedicated to performing the required functions. In another embodiment of the disclosure, the modules 206 may be machine-readable instructions (e.g., software) which, when executed by a processor 202/processing unit, perform any of the described functionalities. Further, the data 208 may function as a repository for storing data processed, received, and generated by one or more of the modules 206. The data 208 may include information and/or instructions to perform activities by the processor 202.

The one or more modules 206 may perform different functionalities which include receiving information and generating the hand pose. However, embodiments are not limited thereto. Accordingly, the one or more modules 206 may include a data harvesting module 210, an insight extraction module 212, a prediction module 214, a query reception module 218, and a recommendation module 216. The data harvesting module 210, the insight extraction module 212, the prediction module 214, the query reception module 218, and the recommendation module 216 may be in communication with each other.

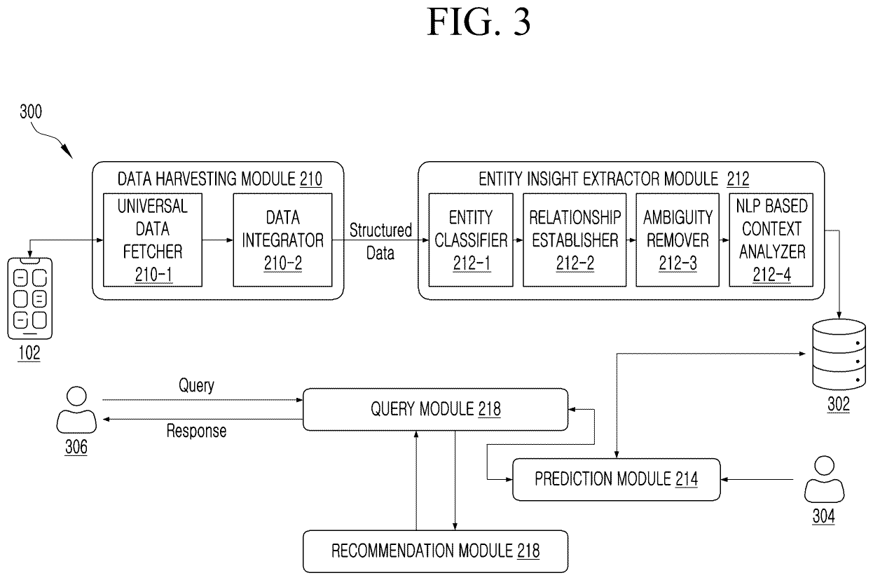

FIG. 3 illustrates a block diagram 300 showing interactions among different modules of the system, according to an embodiment of the disclosure.

Referring to FIGS. 2 and 3, the data harvesting module 210 may include a universal data fetcher 210-1 that is adapted to collect the user data from the plurality of applications 102 (shown in FIG. 1). For example, the data harvesting module 210 may include a data integrity processor 210-2 that is adapted to generate structured user data from the extracted user data. A manner, in which the structured user data is generated, is explained later.

The structured user data may be used later by the insight extraction module 212. The insight extraction module 212 may process the structured user data to identify a plurality of parameters associated with the user's behavior. In an example, insight extraction module 212 may analyze one or more entities, relations, and contexts in a structured user data using an ML model to determine the plurality of parameters. For instance, the plurality of parameters may include the number of occurrences of a word in a conversation. In an example, the insight extraction module 212 may include an entity classifier 212-1 that identifies the entities. Further, the insight extraction module 212 may include a relationship establisher 212-2 that identifies a relationship between the entities. Furthermore, the insight extraction module 212 may include an ambiguity remover 212-3 that removes duplicates from the identified entities and associated relations. Furthermore, the insight extraction module 212 may include context analyzers 212-4 that identifies contexts in the user data based on the identified entities and relations. The context may be understood as an event associated with entities and relations.

In an embodiment, the prediction module 214 may be coupled to a server 302 to receive and process the plurality of parameters to perform prioritization and contextualization. For instance, the prediction module 214 may identify at least one behavioral pattern of the user's behavior based on the identified plurality of parameters. For example, the prediction module 214 may map the at least one behavioral pattern to the contexts. Further, the prediction module 214 may prioritize the plurality of entities and relations based on the mapped at least one behavioral pattern. The prediction module 214 may predict user priority based on the mapped at least one behavioral pattern. In an example, the user priority is indicative of the relevance and importance of entities and associated relations. Further, the prediction module 214 may update the priority in real time based on a change in the user priority.

The prediction module 214 may analyze the user's behavior 304 in real time to process subsequent user data and may identify changes in at least one behavioral pattern. In case there is a change in the behavioral pattern, the prediction module 214 may update the at least one behavioral pattern based on the subsequent user data.

Furthermore, the prediction module 214 may predict, using a machine learning (ML) model, a plurality of chains of thought based on the priority. Once the prediction module 214 predicts the plurality of the chains of thought, the prediction module 214 may identify the chain of thought with the highest probability of occurrence by comparing the plurality of chains of thought using the ML model. The prediction module 214 may then prioritize and contextualize user data using the identified chain of thought with the highest probability of occurrence. A manner, in which the prediction module 214 operates, is explained later.

In an example, the query reception module 218 may receive a query from the user 306. The query reception module 218, based on a type of input, may implement natural language processing techniques to understand the query. Based on the query, the prediction module 214 may select the chain of thought with the highest probability of occurrence. Finally, the recommendation module 216 may use the selected chain of thought to prioritize and contextualize the user data before presenting or outputting the prioritized and contextualized user data to the client.

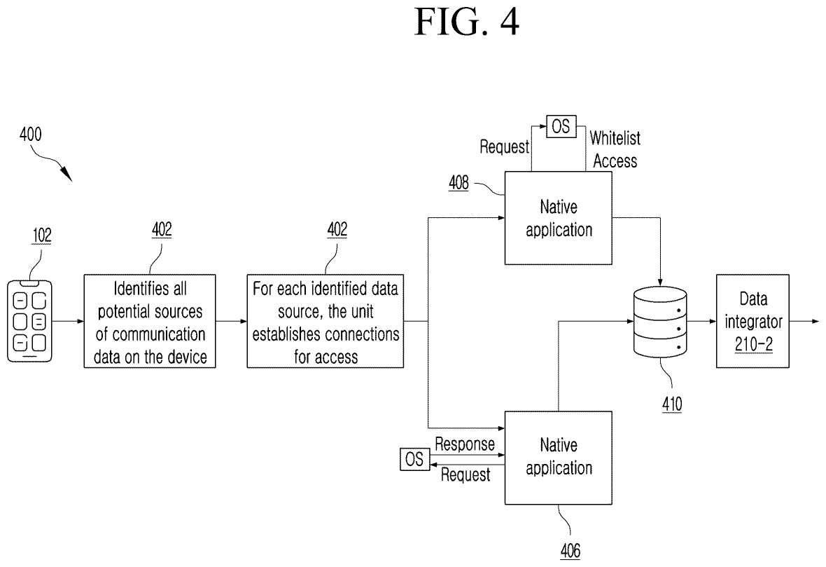

FIG. 4 illustrates a flow diagram 400 of the universal data fetcher 210-1, according to an embodiment of the disclosure. Initially, at block 402, the universal data fetcher 210-1 may identify all potential sources of communication on the UE 100. In an example, the identified potential sources may include the plurality of applications 102. Further, the data source identifier 404 may request an operating system (OS), such as Android® or iOS® to provide a list of access to the applications installed on the UE 100. In an example, the plurality of applications may include native applications and non-native applications. Native applications may include the applications that are integrated into the OS. Examples of native applications include a Message application, a Call application, a Notes application, a Mail application, a Photos application, a File manager application. For example, the non-native applications may be understood as the application that is installed on the OS via an application store. Examples of non-native applications include WhatsApp®, Gmail®, Outlook®, and MakemyTrip®.

In the case of the native application, the universal data fetcher 210-1 may send a request to the OS to access the user data stored in the native applications at block 406. In response, the OS may grant the request and allow the universal data fetcher 210-1 to fetch the user data. The user data fetched by the universal data fetcher 210-1 may include names of contacts, associated contact details, text messages, images, and call logs. In the case of non-native applications, the universal data fetcher 210-1 may request the OS to provide whitelist access to the universal data fetcher 210-1 at block 408.

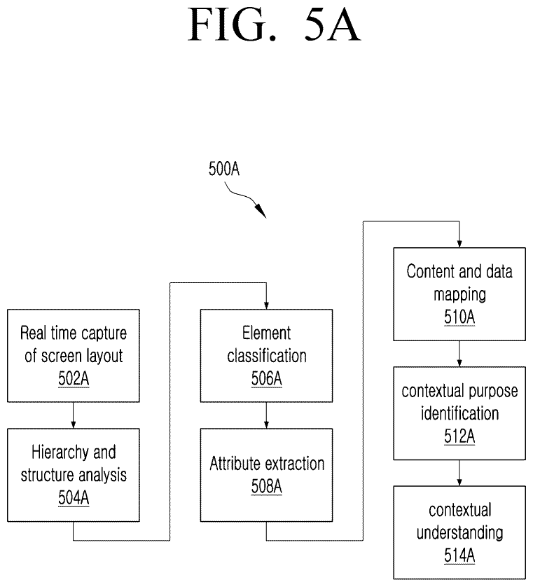

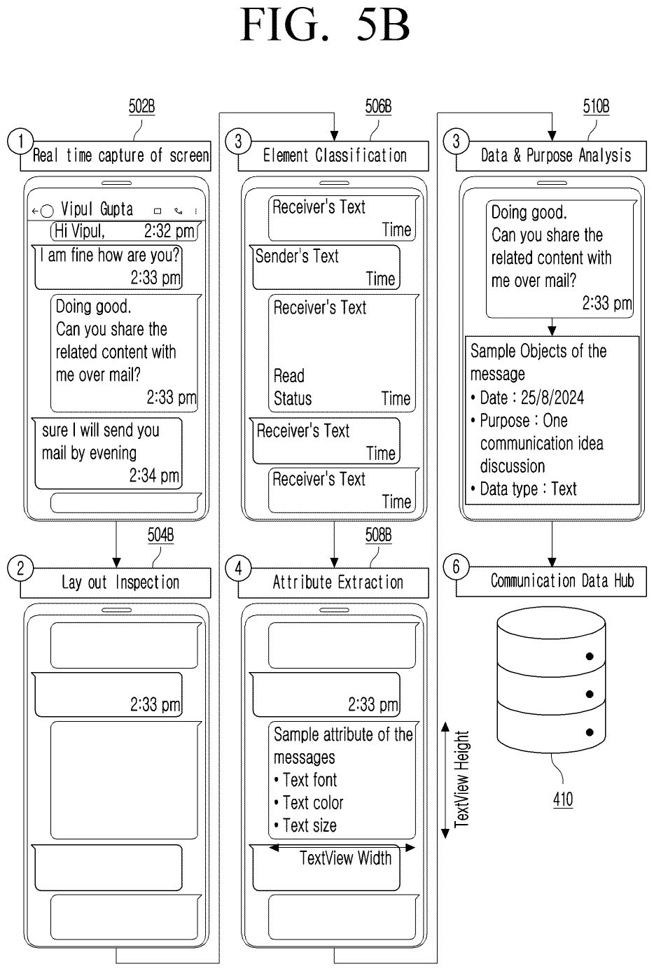

Once the data sources are identified, the universal data fetcher 210-1 may establish a connection to access the data. The non-native applications may verify the whitelist access and may allow the universal data fetcher 210-1 to map, analyze, and interpret the visual layout. Once the universal data fetcher 210-1 has performed the aforementioned functions, the universal data fetcher 210-1 may provide the extracted data to a data repository 410 and subsequently to the data integrity processor 210-2. A manner, in which the universal data fetcher 210-1 generates user data from the non-native application, is explained with respect to FIGS. 5A and 5B.

FIG. 5A illustrates a flow diagram 500A illustrating capturing data from a non-native application whereas FIG. 5B illustrates a flow diagram 500B showing image processing of a screen recording for capturing data from the non-native application, according to an embodiment of the disclosure. At block 502A, the universal data fetcher 210-1 may perform real-time capture of the non-native application displayed on the I/O interface of the UE 100 to receive a screen recording of non-native applications. The universal data fetcher 210-1 may receive the screen recording for a set of non-native applications among the plurality of applications installed on the UE. Further, the screen recording may include user data available in the non-native applications. As an example embodiment, as seen at corresponding block 502B in FIG. 5B, a screen recording of a text messaging application is received.

At block 504A, the universal data fetcher 210-1 may apply media processing technique (or media processes) to determine the layout of the non-native application. As part of determining the layout, the universal data fetcher 210-1 may perform hierarchy and structure analysis which include identifying a manner in which the text messages are laid on the interface of the non-native application. An example embodiment showing the identified layout may be shown at the corresponding block 504B in FIG. 5B.

Once the layout is determined, the universal data fetcher 210-1 may perform element classification at block 506A in FIG. 5A. The universal data fetcher 210-1 may determine entities to which the text belongs based on the identified layout. For example, as shown in corresponding block 506B in FIG. 5B, the universal data fetcher 210-1 may determine that left-aligned text layout belongs to the sender whereas the right-aligned text layout belongs to the receiver. Such information may be needed to identify the contexts of the conversation between the entities. Further, at block 508A, the universal data fetcher 210-1 may perform attribute extraction. As part of attribute extraction, the universal data fetcher 210-1 may determine font type, size, and color of the text, as shown at block 508B in FIG. 5A.

Further, at block 510A in FIG. 5A, the universal data fetcher 210-1 may perform the context and data mapping. For example, the universal data fetcher 210-1, at block 512A may perform contextual purpose identification. Furthermore, the universal data fetcher 210-1, at block 514A, may perform contextual understanding. An example embodiment showing the identified data and layout may be seen at corresponding block 510B in FIG. 5B.

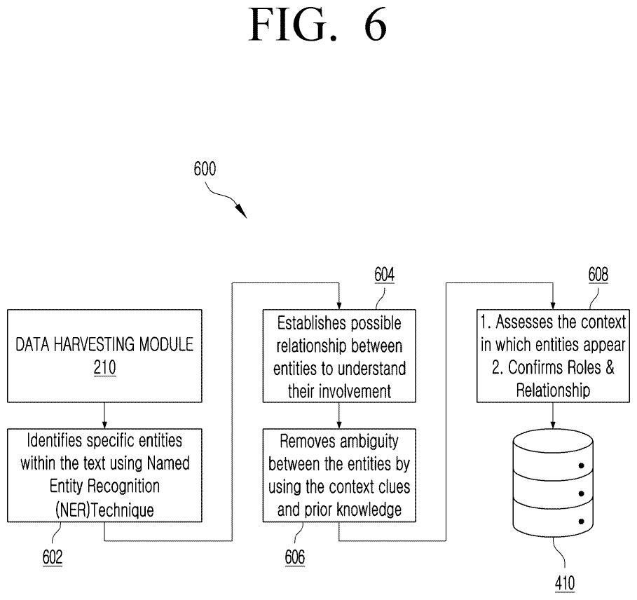

FIG. 6 illustrates a flow diagram 600 of an insight extraction module 212 of the system 200, according to an embodiment of the disclosure. Initially, the insight extraction module 212 may receive the user data from the data harvesting module 210. Thereafter, the entity classifier 212-1 may parse the user data using a machine learning (ML) model to identify the entities. The ML model, in an example, may be a Named Entity Recognition (NER) Technique. For instance, the entity classifier 212-1 may process the following user data extracted from an email communication to identify and classify entities, such as company name, location, and date.

Based in the United Kingdom, Datavid may be a data engineering firm that provides services to organizations around the world since 2018.

Once the entity classifier 212-1 identifies and classifies the entities, the relationship establisher 212-2 may identify relationships in the user data. For instance, the relationship establisher 212-2 may establish possible relationships between entities to understand their involvement. For example, the relationship establisher 212-2 may parse the following text message:
“B'day Party at my place today. Pls join at 8 pm”

In the illustrated example, the relationship establisher 212-2 may identify the entities as Alex and Party, and may identify a relationship of hosting. Once the relationships are identified, the ambiguity remover 212-3 may identify entities and relationships that have different or variant names. Such entities and relationships, though same may be considered as distinct entities and relationships and may be misinterpreted by the ML model during the determination of the context. The ambiguity remover 212-3 may perform semantic word analysis to identify ambiguous entities and relationships and may remove the identified ambiguous entities and relationships. For example, the ambiguity remover 212-3, using semantic analysis may recognize that “Alex Smith” in an email and “Alex” in a text message refer to the same person. Once the ambiguous entities and relationships are identified and removed, the context analyzer 212-4 may identify the contexts in the user data based on the identified entities and relations. The context may be understood as indicating an event associated with entities and relationships. For example, the context analyzer 212-4 may check, using the semantic analysis to determine the context of the following text message.
“Alex invites me to B'day party today”
Entities: Alex, Party
Date: Today
Context: Alex's B'day Celebration

The identification of the context may be important to predict the user's future actions. For instance, in the aforementioned example, the predicted action may include purchasing a gift or booking a cab to the venue. In both possible actions, the user may require AI-based suggestions for selecting a gift and to assist in booking a cab via a dedicated application. The generated entities, relationships, and contexts may be stored in the server 302 for further processing by the prediction module 214.

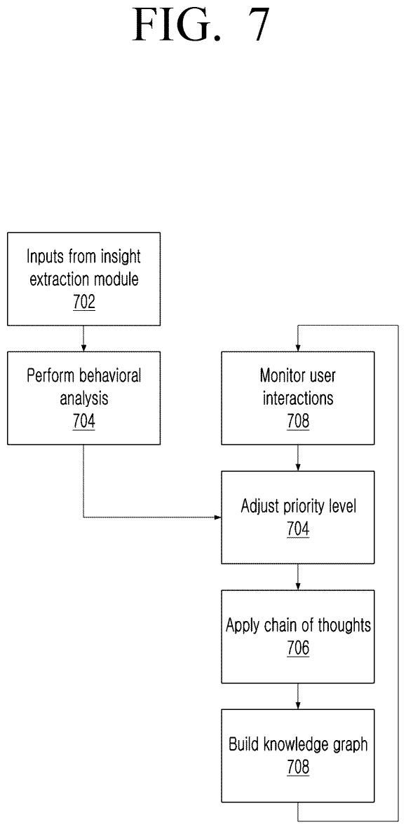

FIG. 7 illustrates a flow diagram 700 of the prediction module 214, according to an embodiment of the disclosure. The prediction module 214, at block 702, may first receive the structured data from the insight generation module 212. For instance, the prediction module 214 may receive identified entities, relationships, sentiments, intents, and contextual groupings. The received structured user data may be graph-ready, with nodes (e.g., entities) and edges (e.g., relationships) defined. Furthermore, the prediction module 214 may also receive contextual (e.g., topics, timelines) and sentimental (e.g., emotional tone) metadata associated with the entities. The metadata may include a timestamp at which the communication is sent or received.

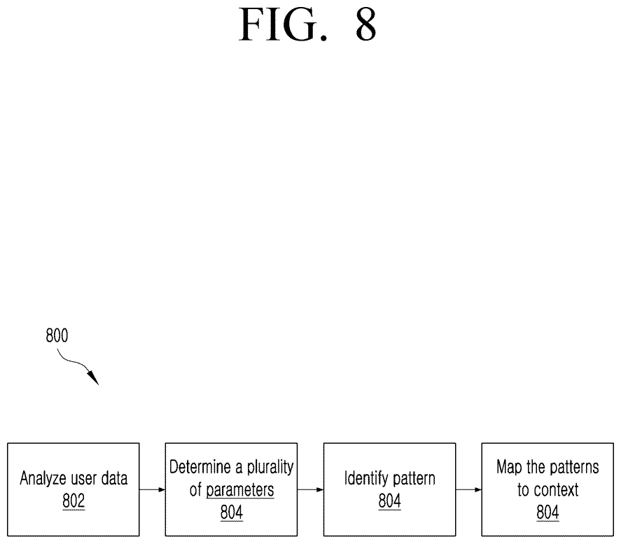

At block 704, the prediction module 214 may perform behavioral analysis. Details of the block 704 are explained in detail in conjunction with reference to FIG. 8. As part of the behavioral analysis, the prediction module 214 at block 802, may analyze the structured user data to determine a plurality of parameters at block 804. The plurality of parameters may include frequency of communication, response times, sentiment trends, topics of interest, timings of the day, location, recency, context, and category. However, embodiments are not limited thereto. Based on the identified parameters, the prediction module 214, at block 806, may identify a pattern in the user's behavior. For instance, the prediction module 214, based on the timing of the day and frequency of communication, may determine that a user tends to prioritize work-related emails during weekdays and personal messages during weekends. Such patterns may allow the prediction module 214 to predict user priority based on the time at which a query is received. Once the pattern is determined, the prediction module 214, at block 808, may map the behavioral patterns to specific contexts, recognizing that the user exhibits different priorities in different scenarios. For example, the prediction module 214 may map an identified work-related pattern with working hours during the weekday.

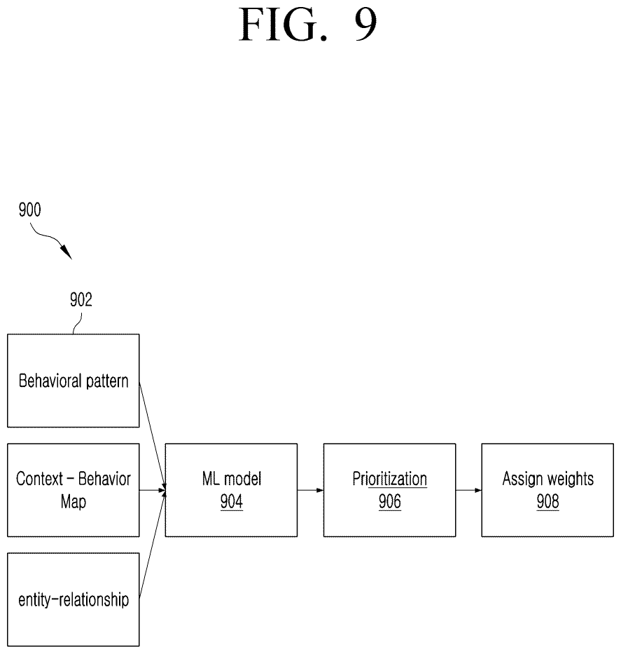

Referring to FIG. 7, the prediction module 214 may prioritize the plurality of entities and relations based on the mapped at least one behavioral pattern at block 706. A manner, in which the prediction module 214 may prioritize the plurality of entities and relationships, is explained in detail with respect to FIG. 9. The prediction module 214 may receive the behavior pattern, a context-to-behavior map, and entity relationship at block 902. Further, the prediction module 214 may provide the behavior pattern, the context-to-behavior map, and the entity relationship to an ML model at block 904. The ML model may analyze the behavior pattern, and the context-to-behavior map to determine the relevance of and importance of entities and relationships. For instance, the ML model may predict that the user is likely to prioritize work-related communications over personal messages during working hours. Therefore, the entities, such as colleagues, client meetings, team meetings, and associated relationships are prioritized at block 906. Further, since the user behavior varies during the day and during the week, the ML model may dynamically adjust the priority in real-time.

Simultaneously, the prediction module 214 may actuate the ML model to assign weights to the prioritized entities at block 908. Further, the prediction module 214 may continuously monitor changes in behavioral patterns and accordingly, update the assigned weights.

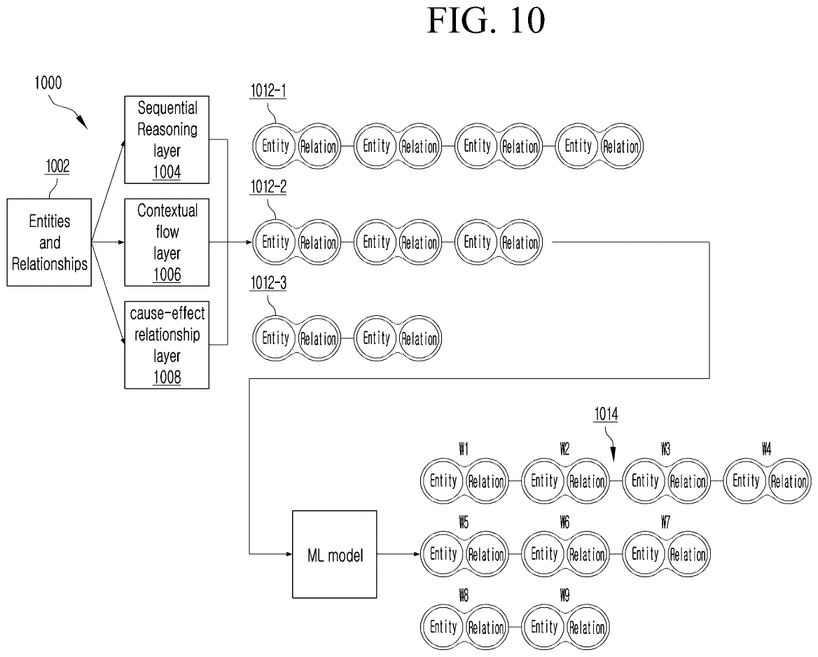

Referring to FIG. 7 again, the prediction module 214 may determine a plurality of chains of thought based on the prioritized entities and relationships at block 708. A chain of thought may be understood as a possible outcome of interaction between the entities and the relations. For example, a chain of thought is a possible outcome of interaction between the entities and relations. The prediction module 214 may use another ML model to predict the chains of thought. A manner, in which the prediction module 214 predicts the chains of thought, is explained with respect to FIG. 10. Initially, the prediction module 214 may receive the entities and relationships at block 1002. Thereafter, the prediction module 214 may actuate a ML model to process the entities and relationships. The ML model in this scenario may include multiple layers that perform the analysis. One of the layers is the sequential reasoning layer at block 1004 which determines how a relationship affects subsequent actions based on the context. Further, at block 1006, a contextual flow layer may perform the mapping of the entities and relationships to the context to predict the transitions between topics of conversation. Furthermore, at block 1008, another layer, i.e., a cause-effect relationship layer may predict a follow-up action based on interaction between two pairs of entities and relationships.

At block 1010, the prediction module 214 may combine the output of the aforementioned layers to produce a plurality of chains of thought 1012-1, 1012-2, and 1012-3, collectively referred to as 1012. The prediction module 214, at block 1014, may use assigned weights to each node, i.e., entities and relationships in the chains of thought.

Referring to FIG. 7 again, the prediction module 214 may build a knowledge graph at block 708. The graph may be based on the weights assigned to the plurality of chains of thought. Further, the prediction module 214 may create clusters of chains of thought based on related entities, for example, based on family members. Such clusters represent different areas of the user's communication landscape (e.g., work and family), with dynamic priority defining the cluster's prominence.

At block 710, the prediction module 214 may update the weights of the plurality of chains of thought based on changes in the user's priority determined by monitoring user interactions. The change in user priority may be detected by the prediction module 214. Specifically, the prediction module 214 may determine that the plurality of parameters, such as location, and repetitive words change which are indicative of a change in the user's priority. Based on the change, the prediction module 214 may reprocess the behavioral pattern in a manner explained with respect to FIGS. 8 to 10.

According to the disclosure, the plurality of chains of thought may be interlinked, as a single event may evolve into multiple directions of chains of thought. Further, the chain which relates more to the user based on predicted priority will be given more weight. Other chains of thought will be weighted accordingly and stay in the background until the dynamic nature of weight by the prediction module 214 brings them in front. By dynamically adjusting which chains are prioritized based on their relevance to the user, the system remains flexible and responsive, ensuring that the most relevant communications are always in focus while other relevant chains of thought are kept in the background until there is a change in priority. Once there is a change in the user's priority, the prediction module 214 may update the weights.

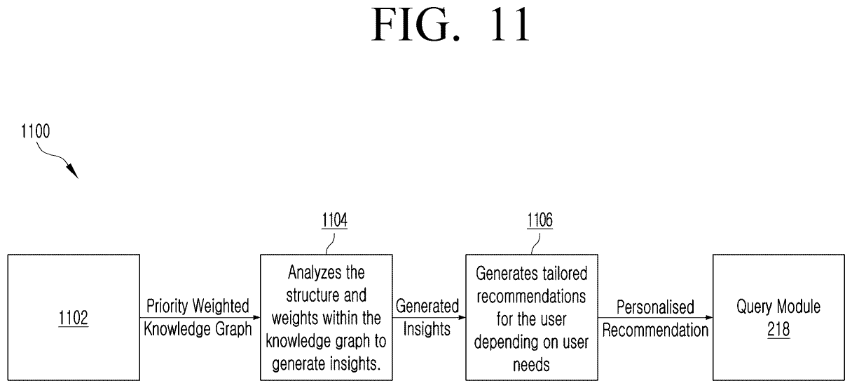

FIG. 11 illustrates a flow diagram 1100 of the recommendation module 216 of the system 200, according to an embodiment of the disclosure. The recommendation module 216 may include the weighted chains of thought. Further, at block 1102, the recommendation module 216 may receive a priority-weighted knowledge graph. Further, at block 1104, the recommendation module 216 may generate insights from the knowledge graph. The insights may include identification of critical communications and recurring patterns. The criticality of a communication may be determined by the time stamp associated with the communication. The insights may be indicative of markers that allow the recommendation module 216 to select the most relevant chains of thought. At block 1106, the recommendation module 216 may generate recommendations.

The recommendation module 216 may use an ML model to compare the plurality of chains of thought using the generated insights. Based on the comparison, the recommendation module 216 may generate recommendations based on factors, such as task prioritization, action reminders, efficiency suggestions, and user feedback loop. The recommendation may further indicate a probability of occurrence of an event. The recommendation module 216 may provide the recommendations to the query reception module 218.

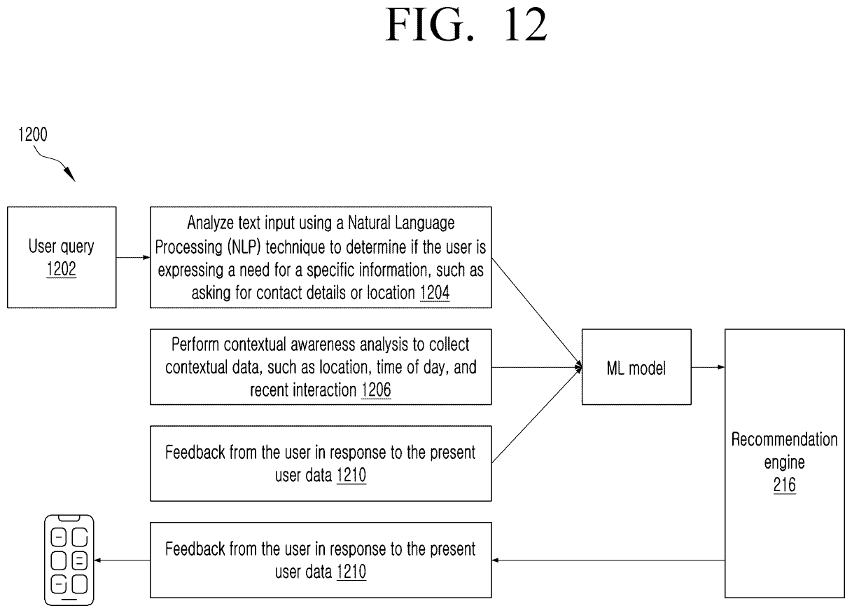

FIG. 12 illustrates a flow diagram 1200 of the query reception module 218 of the system 200, according to an embodiment of the disclosure. The query reception module 218 may receive a user query for one or more applications 102 at block 1202. Further, at block 1204, the query reception module 218 may perform semantic analysis. As part of the semantic analysis, the query reception module 218 may analyze text input using a Natural Language Processing (NLP) technique to determine whether the user is expressing a need for specific information, such as requesting contact details or a location. In another example, the query reception module 218 may use speech-to-text ML models to convert a voice input and generate text based on the voice input.

For example, the query reception module 218 may perform contextual awareness analysis to collect contextual data, such as location, time of day, and recent interaction at block 1206. The query reception module 218 may combine the contextual data and the user's expression to generate a user's request. The query reception module 218 may provide the combination to an ML model at block 1206. The query reception module 218 may compare the user's request with the recommendation provided by the recommendation module 216. Based on the comparison, the query reception module 218 may select the chain of thought having the highest degree of similarity with the user's request. Based on the comparison, the query reception module 218 may select the corresponding chain of thought. The query reception module 218 may then prioritize the presentation of user data based on the chains of thought, at block 1208. Further, the query reception module 218 may implement known generative AI techniques to contextualize and prioritize the user data and to output the contextualized and prioritized user data via the I/O interface 104. In an example, the query reception module 218 may receive feedback from the user in response to the presented user data and may learn from the feedback at block 1210.

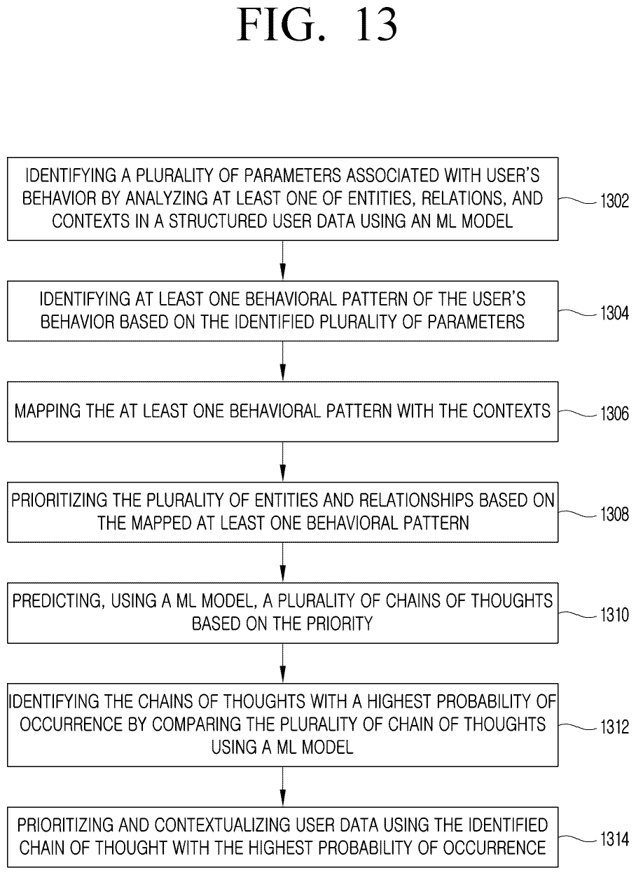

The disclosure relates to a method 1300, illustrated in FIG. 13 for validating access to the electronic device, according to an embodiment of the disclosure. The order in which the method steps are described below is not intended to be construed as a limitation, and any number of the method steps described may be combined in any appropriate order to execute the method or an alternative method. Additionally, individual steps may be deleted from the method without departing from the spirit and scope of the subject matter described herein.

In an example, the method 1300 may be performed partially or completely by the system 200 shown in FIG. 2.

In an embodiment, the method 1300, at step 1302, may include identifying a plurality of parameters associated with a user's behavior by analyzing at least one of entities, relations, and contexts in a structured user data using an ML model.

Once the unlocking operation is detected, at step 1304, at least one behavioral pattern of the user's behavior may be identified based on the identified plurality of parameters.

At step 1306, the at least one behavioral pattern may be mapped to the contexts

At step 1308, the plurality of entities and relations may be prioritized based on the mapped at least one behavioral pattern.

At step 1310, a plurality of chains of thought may be predicted, using an ML model, based on the priority.

At step 1312, the chain of thought with a highest probability of occurrence may be identified by comparing the plurality of chains of thought using a ML model.

Finally, at step 1314, user data may be prioritized and contextualized using the identified chain of thought with the highest probability of occurrence.

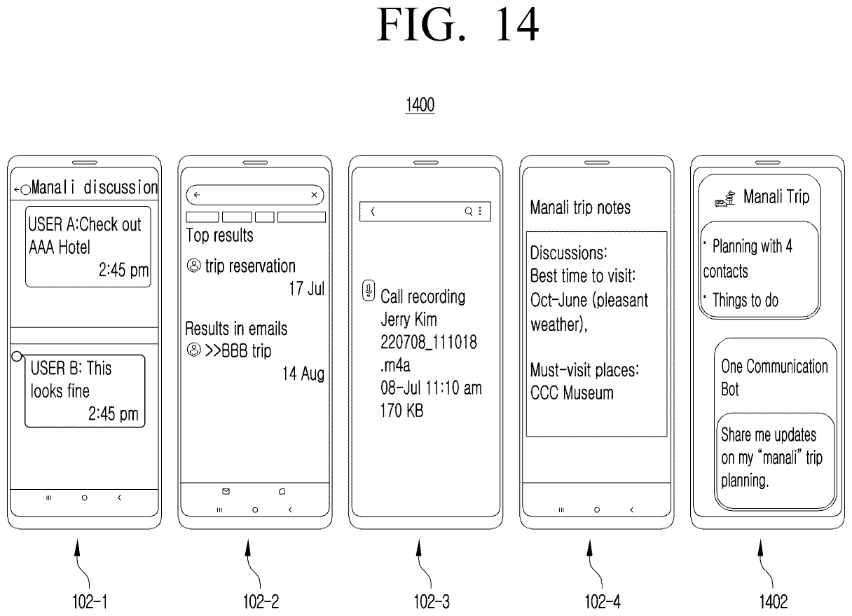

FIG. 14 illustrates an example embodiment 1400 of the working of the system 200, according to an embodiment of the disclosure. In the illustrated embodiment, the system 200 may collect a user data from a plurality of applications 102-1, 102-2, 102-3, and 102-4. The collected user data may include text conversation a text message application 102-1, a booking confirmation from a mailing application 102-2, call recordings from a recorder application 102-3, and itinerary notes from a notes application 102-4. Further, a user may input a voice query 1402 via the I/O interface 104. In response, the system 200 may process the information in a manner explained above to out-prioritize and contextualize the user data. Such an approach may alleviate the need by the user to open all the applications.

Accordingly, the disclosure helps in achieving the following advantages:

The system 200 may allow the user to manage their communications more effectively and may empower the user to remain organized, responsive, and in control of their digital interactions.

The system 200 may provide streamlined access to the user data to the user and may alleviate the need to switch between applications. Further, the system 200 may allow the user to find chats, files, and contacts instantly.

The system 200 may improve work efficiency as the user has to spend less time searching, hence getting the work done in a more efficient manner.

The system 200 may reduce the confusion and miscommunication by ensuring that relevant context is available in a unified interface.

The system 200 may simplify the data organization and may maintain information in an orderly and accessible manner without loss of information.

The system 200 may enable data privacy by performing computation on-device, without transmitting user-sensitive information to third-party cloud services.

While example embodiments has been presented in the foregoing detailed description, it will be appreciated that numerous variations exist.

What is claimed is:

1. A method for prioritizing and contextualizing user data on a user equipment, the method comprising:
identifying a plurality of parameters associated with user behavior by analyzing at least one of entities, relations, and contexts in structured user data using a machine learning (ML) model;
identifying at least one behavioral pattern of the user behavior based on the plurality of parameters;
mapping the at least one behavioral pattern to the contexts;
prioritizing the entities and the relations based on the mapped at least one behavioral pattern;
predicting, using the ML model, a plurality of chains of thought based on priority of the entities and the relations;
identifying a chain of thought having a highest probability of occurrence, among the plurality of chains of thought, by comparing the plurality of chains of thought using the ML model; and
prioritizing and contextualizing the user data based on the chain of thought having the highest probability of occurrence.

2. The method of claim 1, wherein a chain of thought among the plurality of chains of thought indicates a possible outcome of interaction between the entities and the relations.

3. The method of claim 1, further comprising:
receiving a user query through the user equipment;
identifying a user request based on the user query; and
outputting the prioritized and contextualized user data in response to the user request.

4. The method of claim 1, further comprising:
obtaining user data and associated metadata from a set of native applications among a plurality of applications associated with an operating system of the user equipment; and
obtaining a screen recording of a set of non-native applications among a plurality of applications installed on the user equipment, the screen recording comprising user data provided by the set of non-native applications;
processing the screen recording using a media process to extract a layout, elements, and attributes of the set of non-native applications; and
identifying the user data based on the layout, the elements, and the attributes of the set of non-native applications.

5. The method of claim 1, further comprising:
generating the structured user data based on user data collected by a plurality of applications running on the user equipment; and
identifying at least one of the entities, the relations, and the contexts by processing the structured user data using the ML model.

6. The method of claim 5, wherein the generating the structured user data comprises:
identifying entities in the user data, the entities comprising at least one of a person, a place, a location, and an object;
identifying relations between the identified entities;
removing duplicates from the identified entities and the identified relations; and
generating the structured user data by identifying contexts in the user data based on the identified entities and the identified relations, the contexts of the user data indicating events associated with the identified entities and the identified relations.

7. The method of claim 1, further comprising:
predicting user priority based on the mapped at least one behavioral pattern, the user priority indicating relevance and importance of the entities and the relations; and
updating the user priority in real time based on a change in the user priority.

8. The method of claim 1, further comprising:
processing subsequent user data to identify a change in the at least one behavioral pattern; and
updating the at least one behavioral pattern based on the subsequent user data.

9. A user equipment comprising:
memory storing instructions; and
at least one processor operatively coupled with the memory,
wherein the instructions, when executed by the at least one processor individually or collectively, causes the user equipment to:
identify a plurality of parameters associated with user behavior by analyzing at least one of entities, relations, and contexts in structured user data using a machine learning (ML) model;
identify at least one behavioral pattern of the user behavior based on the plurality of parameters;
map the at least one behavioral pattern to the contexts;
prioritize the entities and the relations based on the mapped at least one behavioral pattern;
predict, using the ML model, a plurality of chains of thought based on the priority;
identify the chain of thought having a highest probability of occurrence, among the plurality of chains of thought, by comparing the plurality of chains of thought using the ML model; and
prioritize and contextualize the user data based on the chain of thought having the highest probability of occurrence.

10. The user equipment of claim 9, wherein a chain of thought among the plurality of chains of thought indicates a possible outcome of interaction between the entities and the relations.

11. The user equipment of claim 9, wherein the instructions, when executed by the at least one processor individually or collectively, causes the user equipment to:
receive a user query through the user equipment;
identify a user request by processing the user query;
output the prioritized and contextualized user data in response to the user request.

12. The user equipment of claim 9, wherein the instructions, when executed by the at least one processor individually or collectively, causes the user equipment to:
generate the structured user data based on user data collected by a plurality of applications running on the user equipment; and
identify at least one of the entities, the relations, and the contexts by processing the structured user data using the ML model.

13. The user equipment of claim 9, wherein the instructions, when executed by the at least one processor individually or collectively, causes the user equipment to:
obtain user data and associated metadata from a set of native applications among a plurality of applications associated with an operating system of the user equipment; and
obtain a screen recording of a set of non-native applications among a plurality of applications installed on the user equipment, the screen recording comprising user data provided by the set of non-native applications;
process the screen recording using a media process to extract a layout, elements, and attributes of the set of non-native applications; and
identify the user data based on the layout, the elements, and the attributes of the set of non-native applications.

14. The user equipment of claim 12, wherein the instructions, when executed by the at least one processor individually or collectively, causes the user equipment to:
identify entities in the user data, the entities comprising at least one of a person, a place, a location, and an object;
identify relations between the identified entities;
remove duplicates from the identified entities and the identified relations; and
generate the structured user data by identifying contexts in the user data based on the identified entities and the identified relations, the contexts of the user data indicating events associated with the identified entities and the identified relations.

15. The user equipment of claim 9, wherein the instructions, when executed by the at least one processor individually or collectively, causes the user equipment to:
predict user priority based on the mapped at least one behavioral pattern, the user priority indicating relevance and importance of the entities and the relations; and
update the user priority in real time based on a change in the user priority.
